(19) United States
(12) Patent Application Publication
(10) Pub. No.: US 2023/0305720 A1
(43) Pub. Date: Sep. 28, 2023

(54) RESERVATION OF MEMORY IN MULTIPLE TIERS OF MEMORY

(71) Applicant: Intel Corporation, Santa Clara, CA (US)

(72) Inventors: Slawomir PUTYRSKI, Gdynia (PL); Matthew J. ADILETTA, Bolton, MA (US)

(21) Appl. No.: 18/084,258

(22) Filed: Dec. 19, 2022

(51) Int. Cl. G06F 3/06

(52) U.S. Cl. CPC G06F 3/0631; G06F 3/0659; G06F 3/067; G06F 3/0611

(57) ABSTRACT

Examples described herein relate to a memory controller, when connected to at least one memory device in a multi-tiered memory system comprising a near memory and far memory, is to allocate a region of the near memory to a requester based on receipt of a request. In some examples, the memory controller includes circuitry to transmit at least one memory read command and address information to the multi-tiered memory system to read data from the multi-tiered memory system and circuitry to transmit at least one memory write command and address information to the multi-tiered memory system to write data to the multi-tiered memory system, wherein the near memory comprises at least one memory connected to the memory controller via a memory interface and the far memory comprises at least one memory connected to the memory controller via a network.

### BACKGROUND

Datacenter cloud environments execute workloads for multiple tenants. In the datacenter, resources, such as processors, last-level cache (LLC), or memory bandwidth, are shared among applications. Some datacenter cloud environments execute heterogeneous types of applications and provide a level of quality of service (QoS) performance for applications from utilization of the resources.

FIG. 1 depicts an example system with a multi-level memory system. In a multi-tiered memory system such as two level memory (2LM), at least two types of memory of different characteristics are available, namely, a near memory (NM) 110 and relatively higher latency far memory (FM) 120. Memory controller 104 can select a memory to store data. For example, near memory 110 can be allocated on a first-come first-served basis to applications based on memory accesses. When an application accesses data located in far memory 120, data can be moved or copied to near memory 110. Accordingly, the content of near memory can be based on which data was requested to be accessed. In the multi-tiered memory system, an operating system, hypervisor, and applications executed by processor 100 may not be able to control which physical memories are used.

### BRIEF DESCRIPTION OF THE DRAWINGS

FIG. 1 depicts an example system.

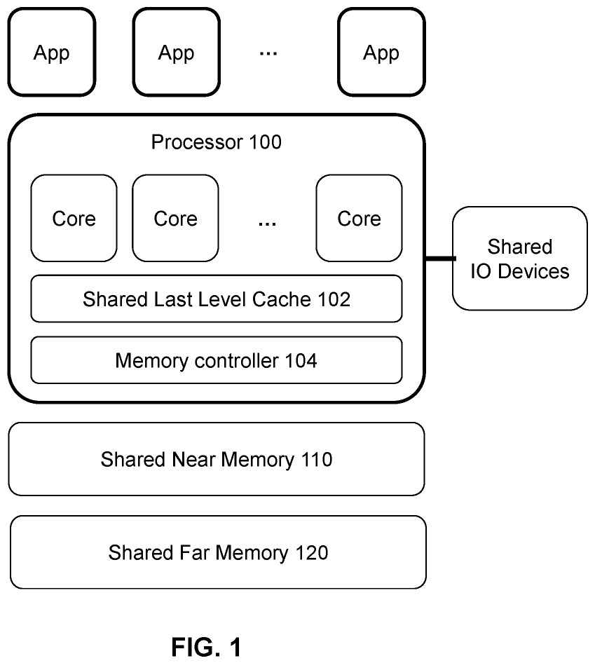

FIG. 2 depicts a noisy neighbor application consuming near memory.

FIG. 3A depicts an example system.

FIG. 3B depicts an example memory controller.

FIG. 4 depicts an example of memory reservation.

FIG. 5 depicts an example process.

FIG. 6 depicts an example system.

### DETAILED DESCRIPTION

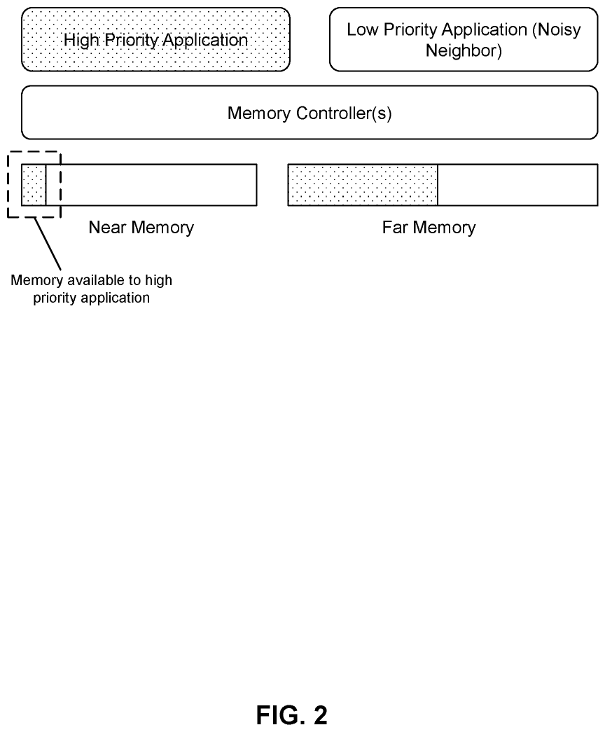

FIG. 2 depicts a noisy neighbor application consuming near memory. While shared memory resources can provide performance scalability and improved throughput for applications, certain types of memory intensive applications such as video streaming or transcoding applications can over-utilize the near memory and can limit utilization of near memory by other applications. For example, when applications of different priorities are executed, e.g., high priority (HP) and low priority (LP) applications, near memory can be consumed by data utilized by an LP application because of their memory utilization characteristics (e.g., video streaming or transcode applications). Accordingly, the LP application can behave as a “noisy neighbor,” and cause an HP application and another LP application to access data more slowly and increase time-to-completion of data processing operations. For example, the HP application and another LP application may not access near memory and, instead, utilize far memory or eviction of data from near memory can occur prior to utilization of near memory. In addition, performance of the HP application can vary over time in the case of long-running workloads or between separate runs of the same workload on the same system. Cloud service providers (CSPs) may not be able to assure proper quality of service (QoS) for certain tenants and tenant applications.

Some examples provide an interface to an operating system (OS) or other process or service to reserve and guarantee an amount of near memory to be available for a process or service despite memory utilization characteristics of other processes or services. In some examples, based on parameters received via the interface, a memory controller can define one or more regions in near memory that can be allocated for exclusive ownership or use by one or more processes. For example, an addressable memory region of near memory can be configured to store data accessible by solely by a process or service and prevent eviction of data from such addressable memory region by another process or service. Near memory allocation allows control over the amount of near memory space that can be consumed by a process or service (e.g., thread, microservice, application, virtual machine (VM), microVM, container in multitenant environment, etc.). Near memory allocation technology may be used to enhance runtime performance, determinism and increase QoS of certain workloads.

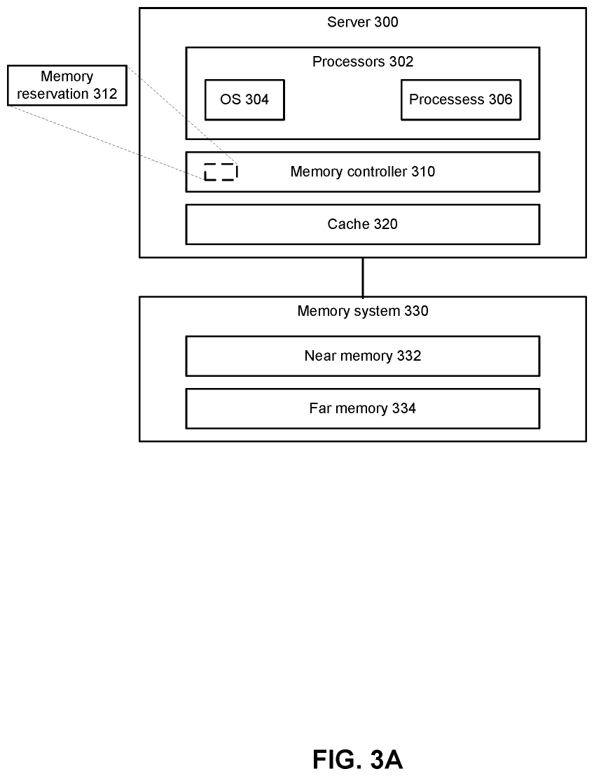

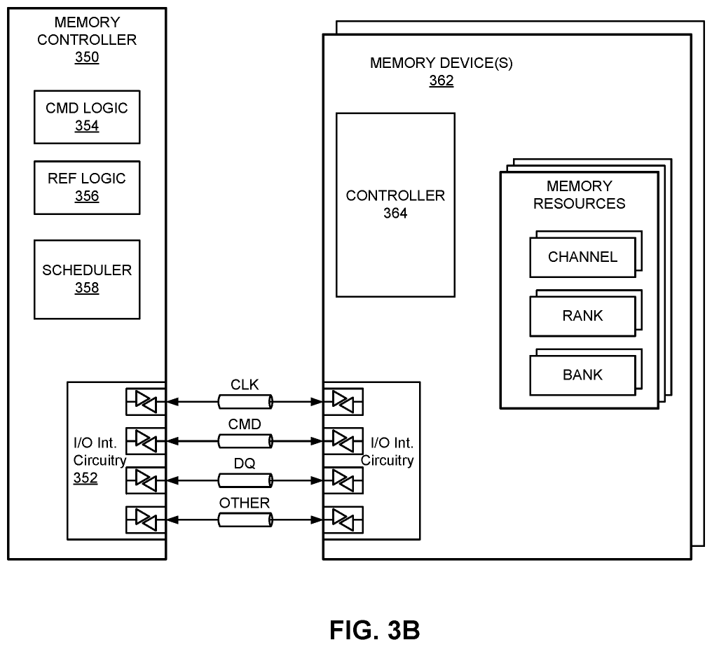

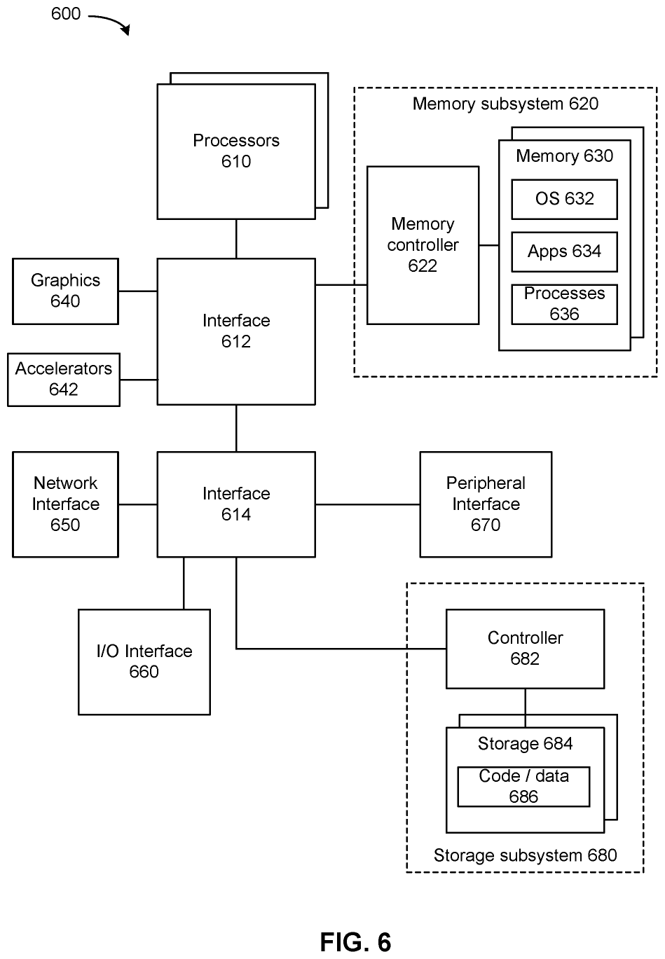

FIG. 3A depicts an example system. Host server system 300 can include processors 302 that execute operating system (OS) 304 and one or more processes 306. Various examples of hardware and software utilized by host server system 300 are described at least with respect to FIG. 6. For example, processors 302 can include a CPU, graphics processing unit (GPU), accelerator, or other processors described herein. Processes 306 can include one or more of: application, process, thread, a virtual machine (VM), microVM, container, microservice, or other virtualized execution environment.

One or more of processes 306 can configure memory controller 310 by communication with OS 304. As described herein, OS 304 can provide one or more of processes 306 with an interface to request an amount of addressable memory in near memory 332 and/or far memory 334 in memory system 330. For example, the interface can be implemented as an application program interface (API), command line interface (CLI), or other interface and can define parameters such as one or more of: [amount of memory to reserve, tier of memory to reserve, requester process identifier (e.g., process address space identifier (PASID), resource monitoring identifier (RMID)), duration of time in which the request is to be active, priority of the request, priority of the requester, level of latency sensitivity of the requester process].

Memory controller 310 can provide processes 306 with access to cache 320 and/or near memory 332 and/or far memory 334 in memory system 330. Memory reservation 312 of memory controller 310 can exclusively allocate access to cache 320 and/or near memory 332 and/or far memory 334 to processes 306 based on at least on the priority of the request or level of latency sensitivity of the requester process. For example, if a region of memory is allocated in response to a request of a first priority (e.g., low or medium) and a higher priority request (e.g., medium or high) is received to allocate a portion of the region of memory, memory reservation 312 can allocate a portion of the region of memory to the higher priority request. For example, if multiple processes of a same priority level request reservation of a region in near memory 332 and/or far memory 334, reservation can be allocated on a first-come, first-served basis. For example, if memory reservation 312 detects that a high priority process is becoming a noisy neighbor, such as the high priority process issuing a threshold number of request reservations of a region, but are not granted reservation, then memory reservation 312 can cause the region to be unallocated to the high priority process or the priority of the high priority processes can be reduced. Memory reservation 312 can arbitrate multiple requests of a same priority level (e.g., requester priority and/or level of latency sensitivity of the requester process) by one or more of: round robin granting of reservation of a memory region, weighted round robin granting of reservation of a memory region, granting of reservation of a memory region based on latency sensitivity of requester process, and so forth.

In some examples, OS 304 can perform eviction of data from near memory 332 to far memory 334 based on frequency of access of data. In some examples, despite reservation of a region of memory, data that is accessed less than a number of times per time interval (e.g., cold data) can be evicted from near memory 332 to far memory 334 and memory allocated to the evicted data can be available for reservation.

Memory controller 310 can issue a read or write command to a memory device of memory system 330 based on an applicable memory protocol. Examples of memory protocols include: DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), or others or combinations of memory technologies, and technologies based on derivatives or extensions of such specifications.

Memory controller 310 can communicate with memory system 330 using a device or memory interface such as one or more of: Peripheral Component Interconnect Express (PCIe), Compute Express Link (CXL), Universal Chiplet Interconnect Express (UCIe), DDR, or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof.

Near memory 332 can include one or more of: one or more registers, one or more cache devices (e.g., level 1 cache (L1), level 3 cache (L2), level 3 cache (L3), last level cache (LLC)), one or more volatile memory device, one or more non-volatile memory device, one or more persistent memory device. For example, near memory 332 can include static random access memory (SRAM) memory technology or memory technology consistent with high bandwidth memory (HBM) or double data rate (DDR). For example, far memory 334 can include volatile memory, non-volatile memory, dual in-line memory modules (DIMMs), and/or one or more of memory pools. A memory pool can be accessed as a local device or a remote memory pool through a device interface (e.g., Peripheral Component Interconnect express (PCIe)), switch (e.g., CXL), and/or network via a network interface device. A memory pool can be shared by multiple servers or processors.

Memory system 330 can include at least two levels of memory (alternatively referred to herein as “2LM” (e.g., regular 2LM, flat 2LM, or dynamic 2LM) or tiered memory) can be used that includes cached subsets of system disk level storage (in addition to, for example, run-time data). Main memory can include a first level (e.g., near memory 332) including lower latency and/or higher bandwidth memory made of, for example, dynamic random access memory (DRAM) or other volatile memory; and a second level (e.g., far memory 334) which can include higher latency and/or lower bandwidth (with respect to near memory 332) volatile memory (e.g., DRAM) or nonvolatile memory storage (e.g., flash memory or byte addressable non-volatile memory (e.g., Intel Optane®)). Far memory 334 can be presented as “main memory” to OS 304, while near memory 332 can store data from far memory 334 in a manner that is transparent to OS 304.

In some examples, memory reservation 312 can be performed by a cache or memory manager circuitry that is part of or separate from memory controller 310 and accessible by processes 306 via OS 304 using an interface. In some examples, memory reservation 312 can be performed by a hypervisor, orchestrator, or OS 304. For example, memory reservation 312 can be performed by Intel® Resource Director Technology (RDT), or technologies can be used with other processor designers or manufacturers including ARM®, Qualcomm®, IBM®, Nvidia®, Broadcom®, Texas Instruments®, among others. For example, RDT can provide software-guided redistribution of cache capacity via cache allocation technology (CAT), enabling important data center requesters to benefit from improved cache capacity and reduced cache contention. For example, CAT can provide an interface for OS 304 or a hypervisor to group requesters into classes of service (CLOS) and indicate the amount of last-level cache available to a CLOS. These interfaces can be based on MSRs (Model-Specific Registers). For example, CAT may be used to enhance runtime determinism and prioritize important requesters such as virtual switches or Data Plane Development Kit (DPDK) packet processing apps from resource contention across various priority classes of workloads. For example, CAT can allow OS 304, hypervisor, or virtual machine manager (VMM) to control allocation of a central processing units (CPU) shared LLC.

FIG. 3B depicts an example memory controller. In some examples, memory controller 350 includes command (CMD) logic 354, which represents logic and/or circuitry to generate commands to send to memory device(s) 362. The generation of the commands can refer to the command prior to scheduling, or the preparation of queued commands ready to be sent. Generally, the signaling in memory subsystems can include address information within or accompanying the command to indicate or select one or more memory locations where memory device(s) 362 should execute the command. In response to scheduling of transactions for memory device(s) 362, memory controller 350 can issue commands via input/output (I/O) interface circuitry 352 to cause memory device(s) 362 to execute the commands. In some examples, controller 364 of memory device(s) 362 can receive and decode command and address information received via I/O interface circuitry 352 from memory controller 350. Based on the received command and address information, controller 364 may control the timing of operations of the logic, features and/or circuitry within memory device(s) 362 to execute the commands. Controller 364 may operate in compliance with standards or specifications such as timing and signaling requirements for memory device(s) 362 (e.g., various JEDEC standards or other public or proprietary standards). Memory controller 350 may implement compliance with standards or specifications by access scheduling and control.

According to some examples, memory controller 350 can include scheduler 358, which can order and generate transactions to send to memory device(s) 362. Memory controller 350 can schedule memory access and other transactions to memory device(s) 362. Such scheduling can include generating the transactions to request data for a processor and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

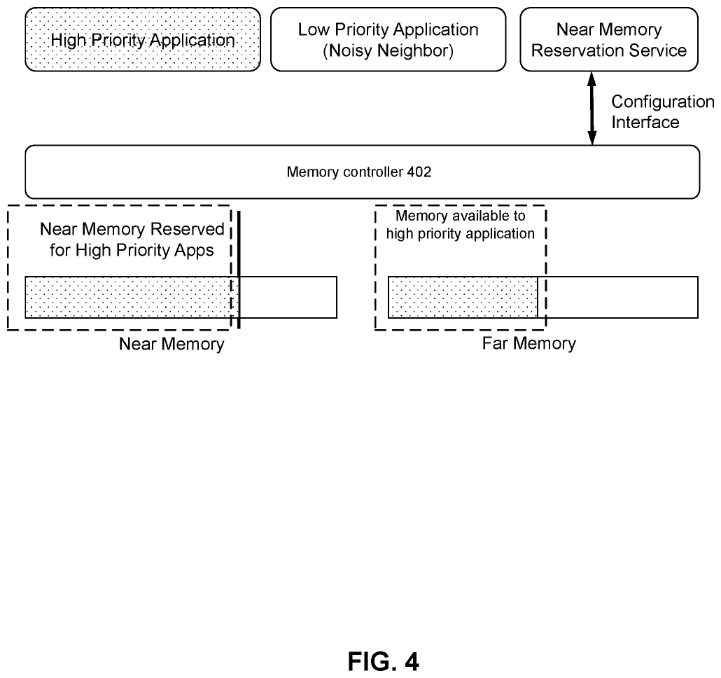

FIG. 4 depicts an example of memory reservation. A system administrator can reserve a configured amount of near memory for exclusive usage by one or more applications (e.g., HP and/or LP). Data of a noisy neighbor application may not be stored in the reserved region and may not cause eviction of application data from the reserved region thereby isolating noisy neighbors from the amount of memory allocated for exclusive usage.

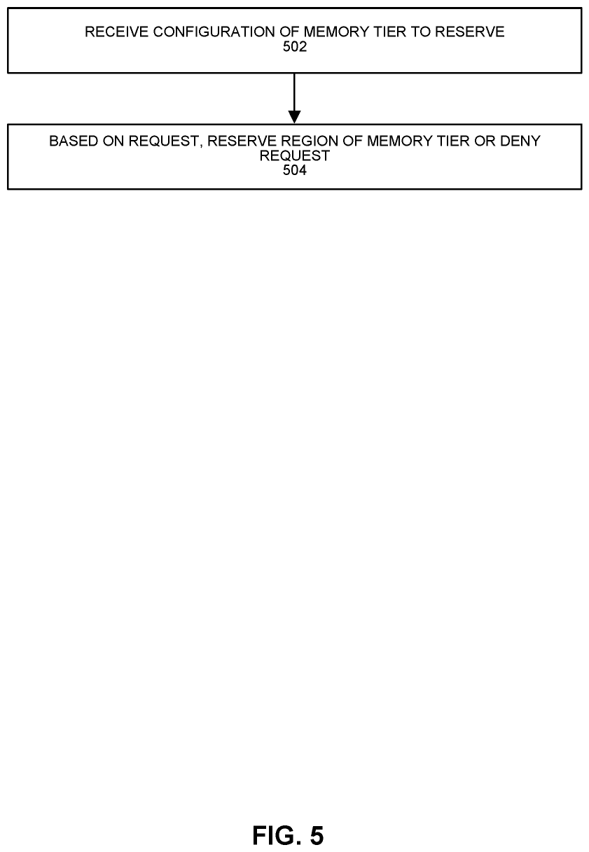

FIG. 5 depicts an example process. The process can be performed by a memory controller of a tiered memory system or other circuitry or software (e.g., OS, hypervisor, orchestrator). At 502, the memory controller can receive a request from an OS requesting to reserve memory for a service. For example, the request can indicate one or more of: requester identifier, amount of memory to reserve, tier of memory in which to reserve memory, level of priority of the requester, latency sensitivity of the requester, or others. At 504, based on the requester being permitted to reserve the region of memory in the associated memory device and the region of memory being available to reserve, the memory controller can exclusively reserve the memory region for the requester. In some examples, the memory controller can deny the request based on one or more of: the region having been reserved for another requester, the request not having a level of priority that meets or exceeds a configured level, the request not having a level of latency sensitivity that meets or exceeds a configured level, or other factors. If an amount of near memory requested to be reserved is not available, memory controller can reserve an amount which is available and notify requesting OS that an amount reserved, which is less than an amount requested to be reserved. If no near memory is available to allocate to the requester, then memory controller can reject a reservation request and indicate the rejection to the requester OS.

FIG. 6 depicts a system. The system can use embodiments described herein to configure a memory controller to reserve a region of memory in a multiple tier memory system, as described herein. System 600 includes processors 610, which provides processing, operation management, and execution of instructions for system 600. Processors 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processors 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 610 can include one or more processor sockets.

In some examples, interface 612 and/or interface 614 can include a switch (e.g., CXL switch) that provides device interfaces between processors 610 and other devices (e.g., memory subsystem 620, graphics 640, accelerators 642, network interface 650, and so forth). Connections provide between a processor socket of processors 610 and one or more other devices can be configured by a switch controller, as described herein.

In some examples, system 600 includes interface 612 coupled to processors 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die.

Accelerators 642 can be a programmable or fixed function offload engine that can be accessed or used by a processors 610. For example, an accelerator among accelerators 642 can provide compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processors 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Applications 634 and/or processes 636 can refer instead or additionally to a virtual machine (VM), container, microservice, processor, or other software. Processes 636 represent agents or routines that provide auxiliary functions to OS 632 or one or more applications 634 or a combination. In some example, memory subsystem 620 includes memory controller 622, which is a memory controller to generate and issue commands to memory 630. It will be understood that memory controller 622 could be a physical part of processors 610 or a physical part of interface 612. For example, memory controller 622 can be an integrated memory controller, integrated onto a circuit with processors 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others. In some examples, OS 632 and/or a driver can configure a memory controller to reserve a region of memory in a multiple tier memory system based on a request from at least one process, as described herein. In some examples, OS 632 can reserve a region of memory in a multiple tier memory system based on a request from at least one process, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In some examples, system 600 includes interface 614, which can be coupled to interface 612. In some examples, interface 614 represents an interface circuit, which can include standalone components and integrated circuitry. In some examples, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory.

In some examples, network interface 650 can be implemented as a network interface controller, network interface card, a host fabric interface (HFI), or host bus adapter (HBA), and such examples can be interchangeable. Network interface 650 can be coupled to one or more servers using a bus, PCIe, CXL, or DDR. Network interface 650 may be embodied as part of a system-on-a-chip (SoC) that includes one or more processors, or included on a multichip package that also contains one or more processors.

In some examples, network device 650 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance (e.g., storage, memory, accelerator, processors, and/or security). Some examples of network device 650 are part of an IPU or DPU or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In some examples, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In some examples, system 600 includes storage subsystem 680 to store data in a nonvolatile manner. In some examples, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processors 610. Whereas storage 684 is nonvolatile, memory 630 can include volatile memory (e.g., the value or state of the data is indeterminate if power is interrupted to system 600). In some examples, storage subsystem 680 includes controller 682 to interface with storage 684. In some examples controller 682 is a physical part of interface 614 or processors 610 or can include circuits or logic in processors 610 and interface 614.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 6G, and variations thereof. Data can be copied or stored to virtualized storage nodes or accessed using a protocol such as Non-volatile Memory Express (NVMe) over Fabrics (NVMe-oF) or NVMe.

In some examples, system 600 can be implemented using interconnected compute nodes of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least some examples may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and includes an apparatus comprising: a memory controller, when connected to at least one memory device in a multi-tiered memory system comprising a near memory and far memory, is to allocate a region of the near memory to a requester based on receipt of a request, wherein the memory controller comprises: circuitry to transmit at least one memory read command and address information to the multi-tiered memory system to read data from the multi-tiered memory system and circuitry to transmit at least one memory write command and address information to the multi-tiered memory system to write data to the multi-tiered memory system, wherein the near memory comprises at least one memory connected to the memory controller via a memory interface and the far memory comprises at least one memory connected to the memory controller via a network.

Example 2 includes one or more examples, wherein the memory controller is to allocate a region of the near memory to the requester based on priority of the request.

Example 3 includes one or more examples, wherein to allocate a region of the near memory to the requester, a processor-executed operating system (OS) is to configure the memory controller to provide access to the region of the memory tier to the requester and no other service.

Example 4 includes one or more examples, wherein the memory controller is to selectively deny the request based on a portion of the region of the memory tier being reserved for another requester.

Example 5 includes one or more examples, wherein the request comprises one or more of: requester identifier, amount of memory to reserve, tier of memory in which to reserve memory, level of priority of the requester, and/or latency sensitivity of the requester.

Example 6 includes one or more examples, and includes the multi-tiered memory system coupled to the memory controller, wherein the multi-tiered memory system comprises one or more of: a volatile memory device and/or a non-volatile memory device.

Example 7 includes one or more examples, and includes a server comprising at least one processor communicatively coupled to the memory controller, wherein the at least one processor is to execute an operating system (OS) to configure the memory controller to provide access to the region of the near memory to the requester.

Example 8 includes one or more examples, and includes at least one non-transitory computer-readable medium comprising instructions stored thereon, that if executed by one or more processors, cause the one or more processors to: execute an operating system (OS) to configure a memory controller, when connected to at least one memory device in a multi-tiered memory system, to allocate a region of a near memory tier to a requester based on a request from the OS.

Example 9 includes one or more examples, wherein the memory controller comprises: circuitry to transmit at least one memory read command and address information to the multi-tiered memory system to read data from the multi-tiered memory system and circuitry to transmit at least one memory write command and address information to the multi-tiered memory system to write data to the multi-tiered memory system.

Example 10 includes one or more examples, wherein allocate a region of a near memory tier to a requester based on a request from the OS, a processor-executed operating system (OS) is to configure the memory controller to provide access to the region of the memory tier to the requester and no other service.

Example 11 includes one or more examples, wherein the multi-tiered memory system comprises the near memory tier and a far memory tier and wherein the near memory tier is to provide a lower latency of data retrieval and/or higher bandwidth of data retrieval than that of the far memory tier.

Example 12 includes one or more examples, wherein the memory controller is to selectively deny the request based on a portion of the region of the memory tier being reserved for another requester.

Example 13 includes one or more examples, wherein the request comprises one or more of: requester identifier, amount of memory to reserve, tier of memory in which to reserve memory, level of priority of the requester, and/or latency sensitivity of the requester.

Example 14 includes one or more examples, and includes a method that includes: in a data center comprising at least one processor, a memory controller, and a multi-tiered memory system: the memory controller allocating a region of a near memory tier of the multi-tiered memory system to a requester based on receipt of a request, the memory controller transmitting at least one memory read command and address information to the multi-tiered memory system to read data from the multi-tiered memory system, and the memory controller transmitting at least one memory write command and address information to the multi-tiered memory system to write data to the multi-tiered memory system, wherein the near memory tier comprises at least one memory connected to the memory controller via a memory interface.

Example 15 includes one or more examples, wherein the memory controller allocating a region of a near memory tier of the multi-tiered memory system to a requester based on receipt of a request is based on a priority level of the request.

Example 16 includes one or more examples, wherein the multi-tiered memory system comprises the near memory tier and a far memory tier and wherein the near memory tier is to provide a lower latency of data retrieval and/or higher bandwidth of data retrieval than that of the far memory tier.

Example 17 includes one or more examples, wherein the region of the memory tier comprises a region of the near memory tier.

Example 18 includes one or more examples, and includes the memory controller selectively denying the request based on a portion of the region of the memory tier being reserved for another requester.

Example 19 includes one or more examples, and includes based on a portion of the region of the memory tier being reserved for another requester, the memory controller accepting the request based at least on the request being associated with a higher priority level than a priority level of the another requester.

Example 20 includes one or more examples, wherein the request comprises one or more of: requester identifier, amount of memory to reserve, tier of memory in which to reserve memory, level of priority of the requester, and/or latency sensitivity of the requester.

What is claimed is:

1. An apparatus comprising:
a memory controller, when connected to at least one memory device in a multi-tiered memory system comprising a near memory and far memory, is to allocate a region of the near memory to a requester based on receipt of a request, wherein the memory controller comprises:
circuitry to transmit at least one memory read command and address information to the multi-tiered memory system to read data from the multi-tiered memory system and
circuitry to transmit at least one memory write command and address information to the multi-tiered memory system to write data to the multi-tiered memory system, wherein the near memory comprises at least one memory connected to the memory controller via a memory interface and the far memory comprises at least one memory connected to the memory controller via a network.

2. The apparatus of claim 1, wherein the memory controller is to allocate a region of the near memory to the requester based on priority of the request.

3. The apparatus of claim 1, wherein to allocate a region of the near memory to the requester, a processor-executed operating system (OS) is to configure the memory controller to provide access to the region of the memory tier to the requester and no other service.

4. The apparatus of claim 1, wherein the memory controller is to selectively deny the request based on a portion of the region of the memory tier being reserved for another requester.

5. The apparatus of claim 1, wherein the request comprises one or more of: requester identifier, amount of memory to reserve, tier of memory in which to reserve memory, level of priority of the requester, and/or latency sensitivity of the requester.

6. The apparatus of claim 1, comprising:
the multi-tiered memory system coupled to the memory controller, wherein the multi-tiered memory system comprises one or more of: a volatile memory device and/or a non-volatile memory device.

7. The apparatus of claim 1, comprising:
a server comprising at least one processor communicatively coupled to the memory controller, wherein the at least one processor is to execute an operating system (OS) to configure the memory controller to provide access to the region of the near memory to the requester.

8. At least one non-transitory computer-readable medium comprising instructions stored thereon, that if executed by one or more processors, cause the one or more processors to:
execute an operating system (OS) to configure a memory controller, when connected to at least one memory device in a multi-tiered memory system, to allocate a region of a near memory tier to a requester based on a request from the OS.

9. The computer-readable medium of claim 8, wherein the memory controller comprises:
circuitry to transmit at least one memory read command and address information to the multi-tiered memory system to read data from the multi-tiered memory system and circuitry to transmit at least one memory write command and address information to the multi-tiered memory system to write data to the multi-tiered memory system.

10. The computer-readable medium of claim 8, wherein allocate a region of a near memory tier to a requester based on a request from the OS, a processor-executed operating system (OS) is to configure the memory controller to provide access to the region of the memory tier to the requester and no other service.

11. The computer-readable medium of claim 8, wherein the multi-tiered memory system comprises the near memory tier and a far memory tier and wherein the near memory tier is to provide a lower latency of data retrieval and/or higher bandwidth of data retrieval than that of the far memory tier.

12. The computer-readable medium of claim 8, wherein the memory controller is to selectively deny the request based on a portion of the region of the memory tier being reserved for another requester.

13. The computer-readable medium of claim 8, wherein the request comprises one or more of: requester identifier, amount of memory to reserve, tier of memory in which to reserve memory, level of priority of the requester, and/or latency sensitivity of the requester.

14. A method comprising:
in a data center comprising at least one processor, a memory controller, and a multi-tiered memory system:
the memory controller allocating a region of a near memory tier of the multi-tiered memory system to a requester based on receipt of a request,
the memory controller transmitting at least one memory read command and address information to the multi-tiered memory system to read data from the multi-tiered memory system, and
the memory controller transmitting at least one memory write command and address information to the multi-tiered memory system to write data to the multi-tiered memory system, wherein the near memory tier comprises at least one memory connected to the memory controller via a memory interface.

15. The method of claim 14, wherein the memory controller allocating a region of a near memory tier of the multi-tiered memory system to a requester based on receipt of a request is based on a priority level of the request.

16. The method of claim 14, wherein the multi-tiered memory system comprises the near memory tier and a far memory tier and wherein the near memory tier is to provide a lower latency of data retrieval and/or higher bandwidth of data retrieval than that of the far memory tier.

17. The method of claim 16, wherein the region of the memory tier comprises a region of the near memory tier.

18. The method of claim 15, comprising:
the memory controller selectively denying the request based on a portion of the region of the memory tier being reserved for another requester.

19. The method of claim 15, comprising:
based on a portion of the region of the memory tier being reserved for another requester, the memory controller accepting the request based at least on the request being associated with a higher priority level than a priority level of the another requester.

20. The method of claim 15, wherein the request comprises one or more of: requester identifier, amount of memory to reserve, tier of memory in which to reserve memory, level of priority of the requester, and/or latency sensitivity of the requester.
